(19) United States
(12) Patent Application Publication
(10) Pub. No.: US 2015/0327956 A1
(43) Pub. Date: Nov. 19, 2015

(54) DENTAL APPLIANCE TO PREVENT MASTICATION

(71) Applicant: Mahnaz Nina Mojaver, San Diego, CA (US)

(72) Inventor: Mahnaz Nina Mojaver, San Diego, CA (US)

(21) Appl. No.: 14/743,791

(22) Filed: Jun. 18, 2015

(51) Int. Cl. A61C 7/08

(52) U.S. Cl. CPC A61C 7/08

(57) ABSTRACT

A device to prevent the mastication of food, consisting of top and bottom retainer elements which are attached to the top and bottom teeth so that they cannot be easily removed, and food barriers extending between the top and bottom retainer elements which prevent food from reaching the chewing surfaces of the teeth, said food barriers allowing the jaws to be fully opened and closed.

### BACKGROUND OF THE INVENTION

1. Field of the Invention

Among the most effective diets is the all liquid diet, based upon an appropriate liquid which contains all of the essential nutrients, without ingredients that add weight.

The most difficult aspect of such a diet is the self-control required to prevent the eating of solid foods.

2. Related Art

While there are other designed products which inhibit the ingestion of solid foods, none of those designs are products which prevent the chewing of solid foods, which chewing is essential for the ingestion of solid foods.

Such devices include U.S. Pat. Nos. 4,738,259 and 4,471,771, Stephen J Brown and Charles E Comstock. '259 is a device and method for disrupting natural mastication. It is based upon the use of an outwardly projecting flange which is attached to a support collar. That device is intended to make chewing more difficult. It does not completely block food from making contact with the tooth surfaces which are responsible for chewing and grinding solid food. In addition, it is extremely cumbersome and uncomfortable for the wearer. It does not retain the teeth in their proper position and it can also be removed by the wearer.

Patent '771 uses a net to capture certain foods and allow other foods that are small particles to pass into the throat. This device has nothing to do with preventing food from being chewed. This device is awkward and uncomfortable and allows food to be trapped in the mouth.

Another device includes US 20030075186A1 (Florman). This device which restricts the distance the wearer can open the mouth. It does not devices prevent the chewing of solid foods.

### SUMMARY

It is therefore an object of the invention to prevent the ingestion of solid foods, by preventing mastication thus forcing the wearer to stay on a pure liquid diet.

It is a further object of this invention that it be comfortable to the wearer and that it allows full range of motion of the jaw so that the wearer's ability to fully open and close the mouth and the wearer's ability to perform all functions of the mouth, other than the chewing of solid food is not in any way impeded.

It is a further object of the invention to ensure that the teeth are retained in their proper position at all times that the device is in place. Without a structure to retain the teeth in their proper position, the use of a device to restrict chewing or any other function of the jaws can result in teeth becoming misaligned.

The above and other objectives of the invention are achieved by a structure which includes upper and lower retainer support elements which are similar to existing devices for the retaining of teeth generally. Attached to the upper and lower retainer support elements are two strips of material, one on each side of the mouth. One end of each strip of material is attached to the upper retainer support element and one end is attached to the lower retained support element. These strips of material are located on the lingual sides of the teeth and adjacent to the premolars and molars, so as to block the passage of food from the mouth to the posterior teeth, thus preventing chewing. The width of the strips is such that it extends across one or more of the premolars and molars. The strips are either attached to the retainer support elements in such a manner that they can move as the mouth is fully opened and closed, or they are made of stretchable material, so that the mouth can be fully opened and closed without interference.

While the invention herein disclosed has been described by means of specific embodiments and applications thereof, numerous modifications and variations could be made thereto by those skilled in the art without departing from the spirit and scope of the appended claims, the invention may be practiced otherwise than as specifically described herein.

### BRIEF DESCRIPTION OF THE FIGURES

FIG. 1 is a side view of the mouth with the jaws in the open position, looking from outside of the mouth to the inside of the mouth, with a food barrier as it is attached to the upper and lower retainer support elements.

FIG. 2 is a view from inside the mouth of the lingual side of the teeth, showing the food barrier as it is attached to the upper and lower retainer support elements.

FIG. 3 is a front view of the mouth in the open position with a food barrier, which is attached to the upper and lower retainer support elements.

FIG. 4 is a side view of the jaws in the open position and containing an elastic food barrier, the view being from the outside looking inward.

FIG. 5 is a side view of the jaws in the open position and containing an elastic food barrier, the view being from the inside of the mouth looking toward the lingual side of the teeth.

FIG. 6 is a frontal view in the open position with the elastic food barrier attached to the upper and lower retainer support elements.

FIG. 7 is a cross sectional view of a tooth showing the mechanism for attaching the retainer support elements to the teeth.

### DETAILED DESCRIPTION

The invention is based upon the manner in which the body processes solid food for ingestion. When solid foods are taken into the mouth, the tongue automatically pushes the food onto the chewing surfaces of the premolars and molars. The idea of the invention is to interfere with the tongue's positioning of food on the teeth, thus preventing chewing, thus preventing the wearer of the invention from ingesting solid food. This allows the utilization of an all liquid diet without the problem of having to use willpower alone to refrain from eating solid foods.

The invention accomplishes this objective by the placement of a food barrier located between the lingual side of the teeth and the tongue. There are a number of shapes for such a barrier and there are a number of ways of mounting such a barrier. In addition, there are a number of materials which could be used for such a barrier.

Among the materials available are plastic, metal, nylon, etc. The preferred material is a soft plastic.

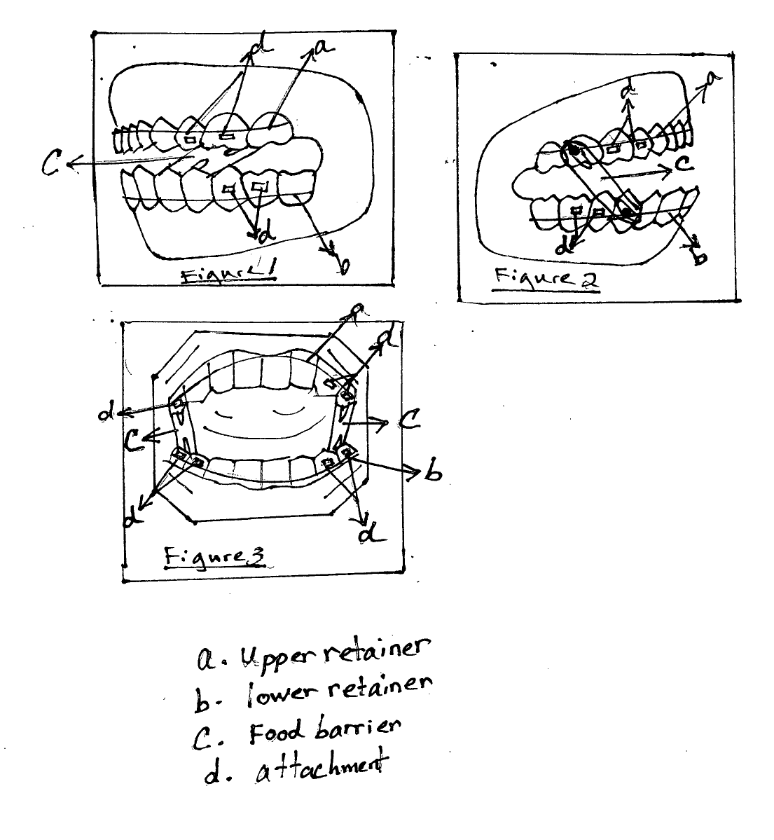

The preferred embodiment is that set forth and shown in FIGS. 1-7.

FIG. 1 is a side view of the mouth with the jaws in the open position looking from outside the mouth to the inside of the mouth. Teeth (1) are covered by retainer support elements (2) and (2a). The retainer support elements are preferably made of clear plastic and are similar to the kind of elements that are used generally to retain teeth.

In this embodiment, the retainer support elements (2) and (2a) are held in place on the teeth by retainers attachments (3). These retainer attachments are attached to the teeth on their buccal side as well as the lingual and palatal side and are preferably implanted by a dentist. Retainer attachments (3) prevent the removal of the retainer support elements (2) and (2a) by the patient. They are preferably removed by a dentist, which prevents the easy avoidance of the strictly liquid diet imposed by the invention. It is known to those skilled in the art to also use cement to hold the retainer support element in place.

The retainer support elements provide the dual function of providing the support for the food barriers as well as insuring that the teeth are retained while the product is being worn.

Food barrier (4) is attached to the upper retainer support element (2) and to the lower retainer support element (2a).

FIG. 2 is a view from inside the mouth of the lingual side of the teeth, showing food barrier (4) as it is attached to upper retainer support element (2) and lower retainer support element (2a). In this embodiment, the upper portion of food barrier (4) is slidably affixed to the upper retainer support element (2) and the lower retainer support element (2a). The slits (5) fit over peg (6), thus allowing food barrier (4) to move up and down as the jaws are opened and closed. The jaws are able to be fully opened and closed.

FIG. 3 is a front view of the mouth in the open position with food barrier (4) and upper retainer support element (2) and lower retainer support element (2a) in place. As can be seen in FIG. 3, food barrier (4) is very thin so as to ensure maximum comfort. While the retainer support elements are shown covering all the teeth, they may in fact be structured so as to cover only a portion of the teeth.

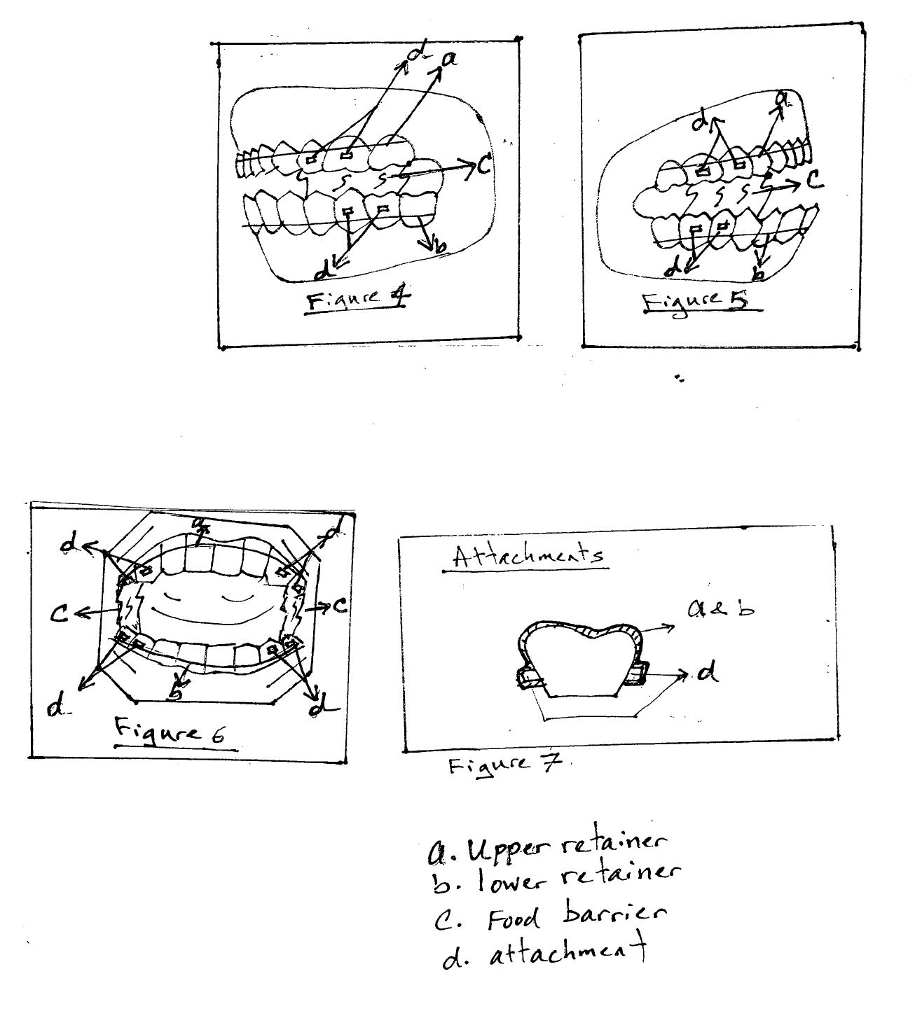

FIGS. 4, 5 and 6 are alternate embodiments of the invention wherein the food barrier is made of an elastic material (5) that can be stretched when the jaws are opened. FIG. 4 is a side view of the jaws in the open position from the outside. FIG. 5 is a side view of the jaws in the open position taken from the inside looking outward, and FIG. 6 is a front view of the jaws in the open position.

FIG. 7 illustrates the mechanism for attaching a support member to the teeth. The clear retainer support element (2) is attached to the teeth (1) by retainer attachments (3) and by clear cement (6). The retainer attachments (3) are on both the lingual and buccal surfaces of the teeth so that the retainer support element (2) will not come off when the wearer opens or closes the jaw and so that it cannot be removed by the wearer without outside assistance such as from a dentist.

The embodiments set forth above are not intended to be exclusive as there may be numerous alternative methods which embody the inventive elements. The essential ingredient of all such products is that there is a barrier which prevents solid food from reaching the chewing surfaces of the teeth.

While the invention herein disclosed has been described by means of specific embodiments and applications thereof, numerous modifications and variations could be made thereto by those skilled in the art without departing from the spirit and scope of the appended claims, the invention may be practiced otherwise than as specifically described herein.

What is claimed is:

1. A dental appliance to prevent mastication comprising:
at least one a retainer support element adapted to be secured to the teeth of the user;
a food barrier affixed to the at least one retainer support element, said food barrier extending from the teeth in the direction of the opposing teeth in the jaw which opposes the jaw in which the teeth are contained, said food barrier being positioned between the tongue and the lingual side of the teeth in the jaw in which the teeth are contained, said food barrier thereby prohibiting food from reaching the chewing surface of the teeth so that the teeth are prevented from masticating solid food.

2. A dental appliance to prevent mastication as defined in claim 1, wherein the at least one retainer support element is secured to the teeth by a third party, such as a dentist, such that it cannot be removed by the wearer.

3. A dental appliance to prevent mastication as defined in claim 1, wherein the at least one retainer support element is configured so as to retain the teeth in their proper position while the dental appliance is in place.

4. A dental appliance to prevent mastication as defined in claim 2, wherein the retainer support element is configured so as to retain the teeth in their proper position while the dental appliance is in place.

5. A dental appliance to prevent mastication as defined in claim 3, wherein the at least one retainer support element includes two retainer support elements, one of which is affixed to the upper teeth and one of which is affixed to the lower teeth.

6. A dental appliance to prevent mastication as defined in claim 4, wherein the at least one retainer support element includes two retainer support elements, one of which is affixed to the upper teeth and one of which is affixed to the lower teeth.

7. A dental appliance to prevent mastication as defined in claim 5, wherein the food barrier is attached to both the upper retainer support element and the lower retainer support element.

8. A dental appliance to prevent mastication as defined in claim 6, wherein the food barrier is attached to both the upper retainer support element and the lower retainer support element.

9. A dental appliance to prevent mastication as defined in claim 7, wherein the food barrier is attached to both the upper retainer support element and the lower retainer support element so that it can move between various degrees of extension depending upon the opening of the jaws.

10. A dental appliance to prevent mastication as defined in claim 8, wherein the food barrier is attached to both the upper retainer support element and the lower retainer support element so that it can move between various degrees of extension depending upon the opening of the jaws.

11. A dental appliance to prevent mastication as defined in claim 9, wherein the retainer support element is affixed by means of at least one retainer attachment attached to at least one tooth.

12. A dental appliance to prevent mastication as defined in claim 10, wherein the retainer support element is affixed by means of at least one retainer attachment attached to at least one tooth.

13. A dental appliance to prevent mastication as defined in claim 11, wherein the food barrier is attached to both the upper retainer support element and the lower retainer support element.

14. A dental appliance to prevent mastication as defined in claim 12, wherein the retainer support element is affixed by means of at least one retainer attachment attached to at least one tooth.

15. A dental appliance to prevent mastication as defined in claim 13, wherein the food barrier is attached to both the upper retainer support element and the lower retainer support element so that it can move between various degrees of extension depending upon the opening of the jaws.

16. A dental appliance to prevent mastication as defined in claim 14, wherein the food barrier is attached to both the upper retainer support element and the lower retainer support element so that it can move between various degrees of extension depending upon the opening of the jaws.

17. A dental appliance to prevent mastication as defined in claim 15, wherein the retainer support element is affixed by cement as well as at least one retainer attachment.

18. A dental appliance to prevent mastication as defined in claim 16, wherein the retainer support element is affixed by cement as well as at least one retainer attachment.

19. A method for preventing mastication comprising:
interposing a food barrier between the chewing surface of one or more teeth and the tongue, so as to prevent solid foods from reaching the chewing surface.

20. A method for preventing mastication as defined in claim 15 wherein the food barrier is attached to at least one retainer support element, which retainer support element is affixed to the teeth.

21. A method for preventing mastication as defined in claim 16 wherein at least one retainer support element is affixed to the teeth by at least one retainer attachment which prevents the retainer support element from being removed by the wearer.
